(19) United States
(12) Patent Application Publication
(10) Pub. No.: US 2026/0071747 A1
(43) Pub. Date: Mar. 12, 2026

(54) LIGHT-EMITTING DEVICE AND LOUDSPEAKER BOX

(71) Applicant: Shenzhen Oceanwing Smart Innovations Technology Co., Ltd, SHENZHEN (CN)

(72) Inventors: Haipeng GUO, SHENZHEN (CN); Po Wei PENG, SHENZHEN (CN); Xiang LI, SHENZHEN (CN)

(73) Assignee: Shenzhen Oceanwing Smart Innovations Technology Co., Ltd, SHENZHEN (CN)

(21) Appl. No.: 19/392,164

(22) Filed: Nov. 18, 2025

Related U.S. Application Data
(63) Continuation of application No. PCT/CN2024/093669, filed on May 16, 2024.

(30) Foreign Application Priority Data
May 18, 2023 (CN) 202321219561.1

(51) Int. Cl. F21V 33/00; F21V 5/04; F21Y 107/50; F21Y 115/10; H04R 1/02

(52) U.S. Cl. CPC F21V 33/0056; F21V 5/04; H04R 1/028; F21Y 2107/50; F21Y 2115/10

(57) ABSTRACT

The present application relates to a light-emitting device and a loudspeaker box. The light-emitting device includes at least two condensing lenses and at least two light sources. The at least two condensing lenses are connected in sequence. At least one of the condensing lenses forms a group. A partition plate is arranged between two adjacent groups of the at least one of the condensing lenses. Each group of the at least one of the condensing lenses and two partition plates adjacent to the group of the at least one of the condensing lenses form a chamber. At least one of the light sources is arranged in each chamber. A light beam emitted by the at least one of the light sources is projected towards a corresponding group of the at least one of the condensing lenses and passes through to the outside of a corresponding chamber.

### CROSS REFERENCE TO RELATED APPLICATIONS

The present disclosure is a continuation of International Patent Application No. PCT/CN2024/093669, filed on May 16, 2024, which claims priority to Chinese Patent Application No. 202321219561.1, filed on May 18, 2023, the entire contents of these applications are incorporated herein by reference.

### TECHNICAL FIELD

The present disclosure relates to the field of loudspeaker box light effect technologies, and in particular to a light-emitting device and a loudspeaker box.

### BACKGROUND

A light effect system of a loudspeaker box is usually arranged with a running light or a beat light that may interact with music rhythm to enhance an atmosphere and expressiveness of the music. Generally, the light effect of the loudspeaker box is presented through a lampshade on a surface of the loudspeaker box, enabling changes of a light source inside the loudspeaker box to be visible. However, the changes of the light effect of the loudspeaker box are often reflected in a specific region on the surface of the loudspeaker box, and the interaction with an external space is relatively weak, which affects the audio-visual experience to a certain extent.

### SUMMARY

According to various embodiments of the present disclosure, a light-emitting device and a loudspeaker box are provided.

The light-emitting device includes: at least two condensing lenses, connected in sequence, at least one of the condensing lenses forming a group, a partition plate being arranged between two adjacent groups of the at least one of the condensing lenses, and each group of the at least one of the condensing lenses and two partition plates adjacent to the group of the at least one of the condensing lenses forming a chamber; and at least two light sources, at least one of the light sources being arranged in each chamber, and a light beam emitted by the at least one of the light sources being projected towards a corresponding group of the at least one of the condensing lenses and passing through to the outside of a corresponding chamber.

The loudspeaker box includes: a loudspeaker box body; the light-emitting device according to the embodiment mentioned above, the light-emitting device being arranged at a bottom of the loudspeaker box body; and a sound effect system, including a loudspeaker and a main circuit board connected to each other, the main circuit board being configured to control a variation of the light sources according to an audio signal.

The details of one or more embodiments of the present disclosure are set forth in the following drawings and description. Other features, objects, and advantages of the present disclosure will become apparent from the description, drawings, and claims.

### BRIEF DESCRIPTION OF THE DRAWINGS

In order to more clearly illustrate the technical solutions in the embodiments of the present disclosure or the technical solutions in the related art, the drawings needed to be used in the description of the embodiments or the related art are briefly introduced below. Obviously, the drawings in the description are only embodiments of the present disclosure. For those of ordinary skilled in the art, other drawings may also be obtained based on the drawings of the present disclosure without creative work.

FIG. 1 is a schematic structure view of a loudspeaker box according to some embodiments of the present disclosure.

FIG. 2 is a schematic cross-sectional view of a loudspeaker box according to some embodiments of the present disclosure.

FIG. 3 is a schematic exploded view of a loudspeaker box according to some embodiments of the present disclosure.

FIG. 4 is a schematic view of a first structure of a light-emitting device according to some embodiments of the present disclosure.

FIG. 5 is a schematic exploded view of a first structure of a light-emitting device according to some embodiments of the present disclosure.

FIG. 6 is a schematic top view of a first structure of a light-emitting device according to some embodiments of the present disclosure.

FIG. 7 is a schematic view of a light beam effect of a light-emitting device according to some embodiments of the present disclosure.

FIG. 8 is a schematic view of a first light beam of a light-emitting device according to some embodiments of the present disclosure.

FIG. 9 is a schematic view of a second light beam of a light-emitting device according to some embodiments of the present disclosure.

FIG. 10 is a schematic view of a second structure of a light-emitting device according to some embodiments of the present disclosure.

FIG. 11 is a schematic view of a third structure of a light-emitting device according to some embodiments of the present disclosure.

FIG. 12 is a schematic view of a fourth structure of a light-emitting device according to some embodiments of the present disclosure.

FIG. 13 is a three dimension cross-sectional view of a fourth structure of a light-emitting device according to some embodiments of the present disclosure.

FIG. 14 is a two dimension cross-sectional view of a fourth structure of a light-emitting device according to some embodiments of the present disclosure.

FIG. 15 is a schematic view of a fifth structure of a light-emitting device according to some embodiments of the present disclosure.

FIG. 16 is a three dimension cross-sectional view of a fifth structure of a light-emitting device according to some embodiments of the present disclosure.

FIG. 17 is a two dimension cross-sectional view of a fifth structure of a light-emitting device according to some embodiments of the present disclosure.

### DETAILED DESCRIPTION

The technical solutions in the embodiments of the present disclosure will be described clearly and completely below in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure.

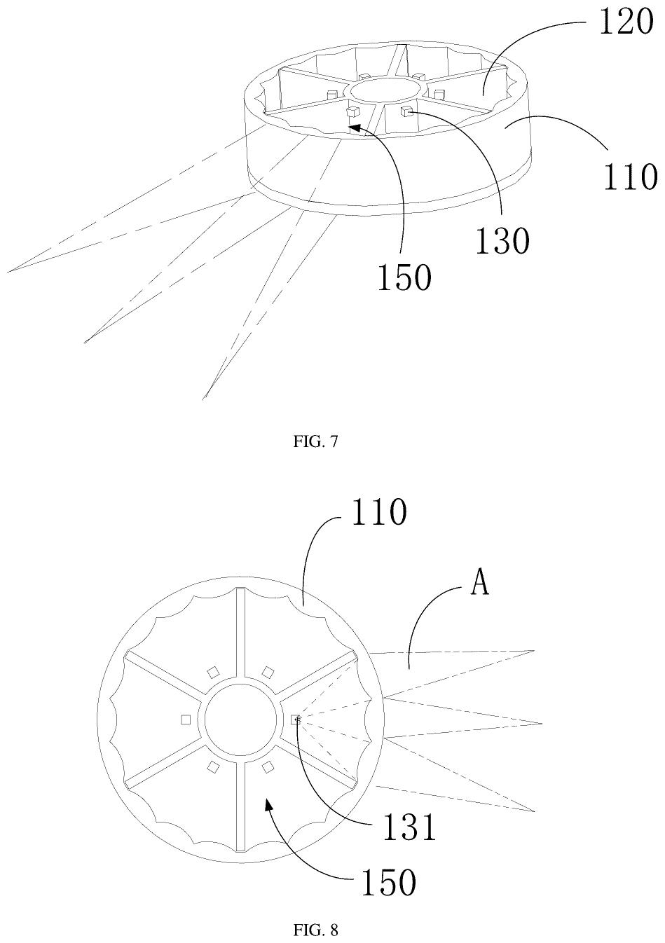

As shown in FIG. 4 to FIG. 6, a light-emitting device 100 provided in some embodiments of the present disclosure includes at least two condensing lenses 110, a partition plate 120, and at least two light sources. The light sources may emit multiple strip light beams through the condensing lenses 110. The condensing lenses 110 are connected in sequence. At least one of the condensing lenses 110 forms a group. The partition plate 120 is arranged between two adjacent groups of the at least one of the condensing lenses 110. In this way, a chamber 150, for arranging at least one of the light sources, is formed by each group of the at least one of the condensing lenses 110 and two partition plates 120 adjacent to the group of the at least one of the condensing lenses 110. As shown in FIG. 7, the light sources in all chambers 150 are separated from each other by the partition plates 120 to avoid mutual interference between the light sources, so that each condensing lens 110 may project a strip light beam to the outside of the corresponding chamber 150. In this way, strip light shadows may be displayed on surfaces of objects such as the ground and walls in an external space, enhancing the visual effect and improving the interactivity of the light beams with the external space. In a case where the light sources are controlled to change, the light beams projected by the light-emitting device 100 to the external space will change synchronously, presenting dynamic strip light beams and enriching the user's visual experience.

In order to further enhance the spatial interactivity of the light-emitting device 100, in some embodiments, the condensing lenses 110 are connected one-by-one to form a ring structure. The ring structure is configured to receive the light beams along an entire circumference of the ring structure and to project the light beams to the outside of the chambers 150. In a case where the light source in the chamber 150 is lit, each condensing lens 110 of the ring structure may project a corresponding light beam to the outside of the chamber 150, forming a 360° transmission light beam effect on a periphery of the light-emitting device 100, thereby further enhancing the spatial interactivity.

As shown in FIG. 10, in some embodiments, each group of the at least one of the condensing lenses 110 forms an arc-shaped structure. Sides of each two adjacent partition plates 120 away from the condensing lenses 110 are connected to each other. Each arc-shaped structure and two partition plates 120 adjacent to the arc-shaped structure form a fan-shaped chamber 151. After the lights from the light sources are emitted from the condensing lenses 110 of the arc-shaped structure respectively, the lights form an approximately fan-shaped region in the external space.

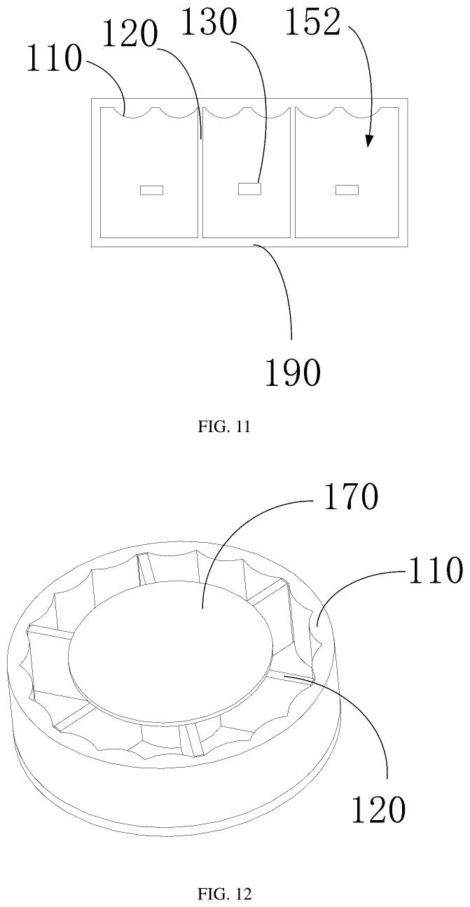

As shown in FIG. 11, in some embodiments, the condensing lenses 110 are connected in sequence and arranged side by side. The light-emitting device 100 further includes a side plate 190. A side of each partition plate 120 away from the condensing lenses 110 is connected to the side plate 190. Each group of at least one of the condensing lenses 110, two partition plates 120 adjacent to the group of at least one of the condensing lenses 110, and the side plate 190 form a columnar chamber 152. The lights from the light sources are emitted from the condensing lenses 110 side by side to form a row of light beams in the external space.

As shown in FIG. 7 and FIG. 8, in some embodiments, in each group of the at least one of the condensing lenses 110, the number of the at least one of the condensing lenses 110 may be set to be two or more than two. The number of the at least one of the condensing lenses 110 in each group is one, two, three, or four. In this way, the number of the light beams projected by the light-emitting device 100 to the external space may be increased, the light beam density may be improved, and the visual effect may be enhanced. In each group of the at least one of the condensing lenses 110, an incident surface and an exit surface of each condensing lens 110 are curved surfaces with different radians. In this way, the light emitted by the light source may enter a corresponding condensing lens 110 in a direction parallel or approximately parallel to a main optical axis of the corresponding condensing lens 110. After exiting, the lights may be condensed into the light beams, so as to improve the consistency of the light beam emitted by each group of the at least one of the condensing lenses 110.

The condensing lenses 110 form six groups, and the six groups of the condensing lenses 110 form six chambers 150 respectively, with each of the six chambers 150 being defined by two partition plates 120 adjacent to a corresponding group of the condensing lenses 110. The light sources in the six chambers 150 are respectively set to emit light of a first color, a second color, a third color, a fourth color, a fifth color, and a sixth color. In this way, light beams of six colors are emitted from the six chambers 150 respectively, resulting in brilliant colors and further enriching the visual experience.

In order to improve the shape of the strip light beams emitted by the condensing lenses 110, in some embodiments, the light sources include a circuit, and each of the light sources includes a lamp bead 130 connected to the circuit. Each of the condensing lenses 110 is a convex lens. An incident surface of each convex lens is perpendicular or approximately perpendicular to a light ray of a corresponding lamp bead 130. In this way, the shape of the strip light beam is improved in a case where the light rat is emitted from the condensing lenses 110, forming the strip light beams with a relatively uniform shape, thereby enhancing the consistency of the light beams. In some embodiments, the lamp bead 130 is a light emitting diode (LED) lamp.

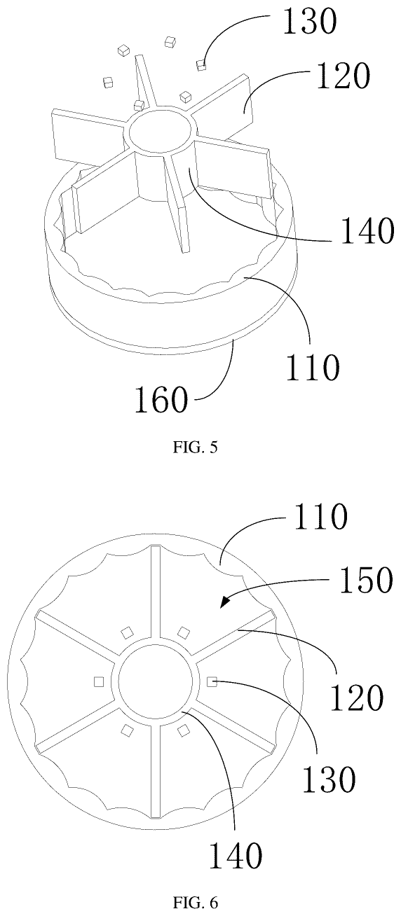

For ease of use, as shown in FIG. 5, in some embodiments, the light-emitting device 100 further includes a base plate 160. The condensing lenses 110, the partition plates 120, and the light sources are all arranged on the base plate 160. The base plate 160 is configured for connecting to a loudspeaker box to facilitate installation.

As shown in FIG. 5, in some embodiments, the light-emitting device 100 further includes a connecting structure 140. The side of each partition plate 120 away from the condensing lenses 110 is connected to the connecting structure 140. The partition plates 120 are connected and fixed by the connecting structure 140. In some embodiments, the connecting structure 140 and the partition plates 120 are of an integrally formed structure, which may be assembled as a whole, simplifying the installation operation.

In order to simplify the structure and ensure that the lights of the light sources may be emitted from the condensing lenses 110 and form the strip light beams, as shown in FIG. 12 to FIG. 14, in some embodiments, the light-emitting device 100 further includes a first lamp board 170. The first lamp board 170 is covered on the connecting structure 140. The light sources are connected to the first lamp board 170. Each of the light sources corresponds to a position of the corresponding chamber 150. The connecting structure 140 includes a reflecting surface 141. The reflecting surface 141 is configured to reflect the light rays of the light sources into incident surfaces of the condensing lenses 110, ensuring that the light rays form the strip light beams after being emitted from the condensing lenses 110. Meanwhile, the structure is simplified, with the installation of all light sources being completed via one first lamp board 170. An angle between the reflecting surface 141 and each condensing lens 110 in a vertical direction only needs to satisfy that after the light from the light source is reflected by the reflecting surface 141, the light may enter the incident surface of the condensing lens 110 perpendicularly or approximately perpendicularly.

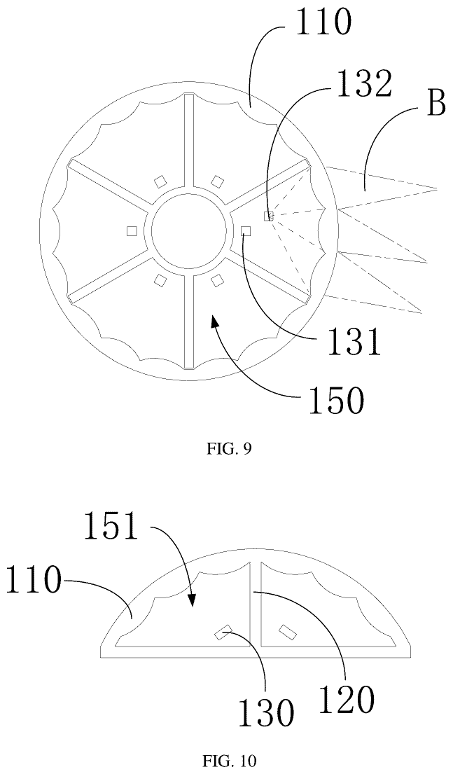

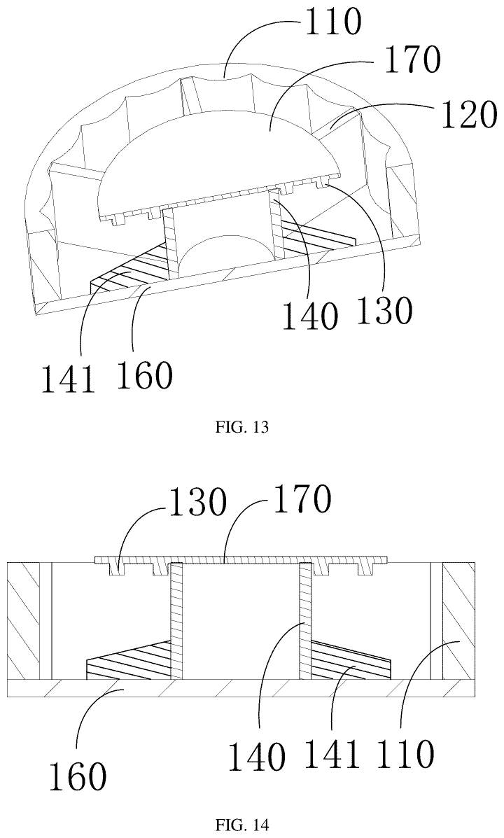

Further, in order to make positions of the lights from the light sources to be variable when exiting the condensing lenses 110, as shown in FIG. 8, FIG. 9, FIG. 13 and FIG. 14, in the above-mentioned embodiments, the number of the light sources in each chamber 150 is two. Both two light sources are arranged on the first lamp board 170. In a case where the two light sources in one chamber 150 are lit respectively, light beams are able to be emitted from the at least one of the condensing lenses 110 of the chamber 150 to different positions in the external space. The two light sources include a first lamp bead 131 and a second lamp bead 132. Each chamber 150 is arranged with the first lamp bead 131 and the second lamp bead 132. The first lamp bead 131 and the second lamp bead 132 are both connected to the first lamp board 170. In a case where the first lamp bead 131 is lit, a first light beam A may be emitted to the external space. In a case where the second lamp bead 132 is lit, a second light beam B may be emitted to the external space. Positions of the first light beam A and the second light beam B projected in the external space are different, which enables the light beams to vary in distance relative to the condensing lenses 110 in the external space and enriches the dynamic variation effect of the light beams.

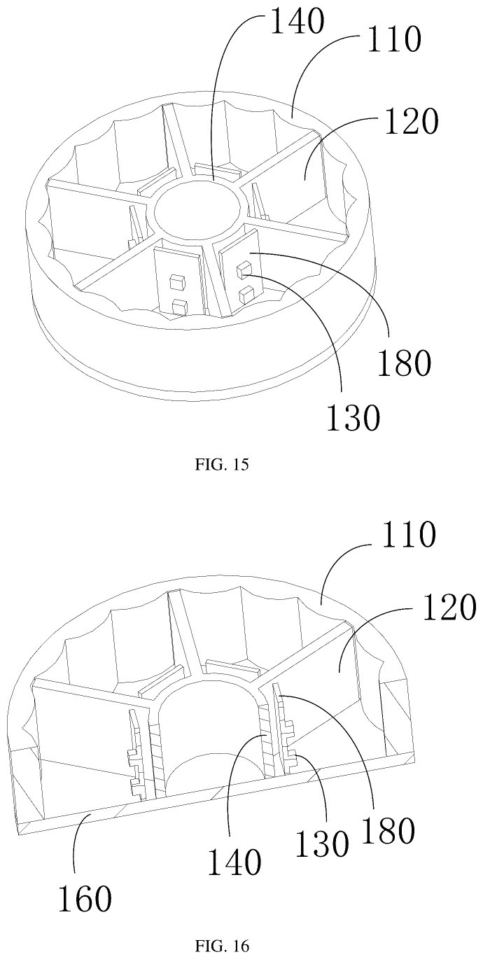

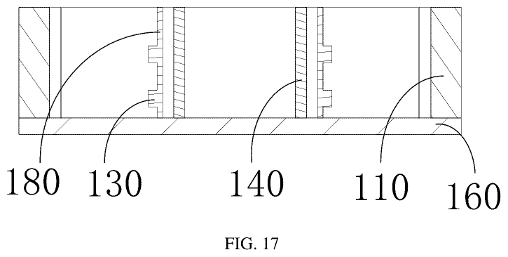

As shown in FIG. 15 to FIG. 17, in some embodiments, the light-emitting device 100 further includes a second lamp board 180. The second lamp board 180 is arranged in the chamber 150. The at least one of the light sources is connected to the second lamp board 180. One second lamp board 180 is arranged in each chamber 150 to install the at least one of the light sources, thereby simplifying the connecting structure 140. In addition, in a case where an individual light source is damaged, a corresponding second lamp board 180 in the chamber 150 may be taken out independently, facilitating maintenance and replacement. The first lamp bead 131 and the second lamp bead 132 are arranged in each chamber 150. The first lamp bead 131 and the second lamp bead 132 are both connected to the second lamp board 180. In this way, the light beams are able to emit at different positions in the external space, allowing the light beams to vary in height relative to the condensing lenses 110 on surfaces such as the ground, walls, or objects in the external space, and enriches the dynamic variation effect of the light beams.

In the above-mentioned light-emitting device 100, the light sources may emit multiple strip light beams through the condensing lenses 110. The condensing lenses 110 are connected in sequence. At least one of the condensing lenses 110 forms one group. The partition plate 120 is arranged between two adjacent groups of the at least one of the condensing lenses 110. In this way, one chamber 150, for arranging at least one of the light sources, is formed by each group of the at least one of the condensing lenses 110 and two partition plates 120 adjacent to the group of the at least one of the condensing lenses 110. The light sources in all chambers 150 are separated from each other by the partition plates 120 to avoid mutual interference between the light sources, so that each condensing lens 110 may project a strip light beam to the outside of the corresponding chamber 150. In this way, strip light shadows may be displayed on surfaces of objects such as the ground and walls in an external space, enhancing the visual effect and improving the interactivity of the light beams with the external space. In a case where the light sources are controlled to change, the light beams projected by the light-emitting device 100 to the external space will change synchronously, presenting dynamic strip light beams and enriching the user's visual experience.

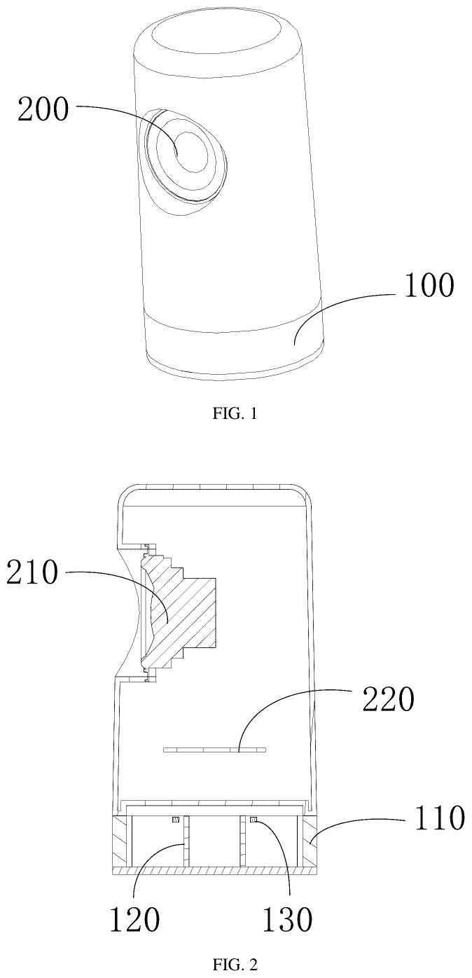

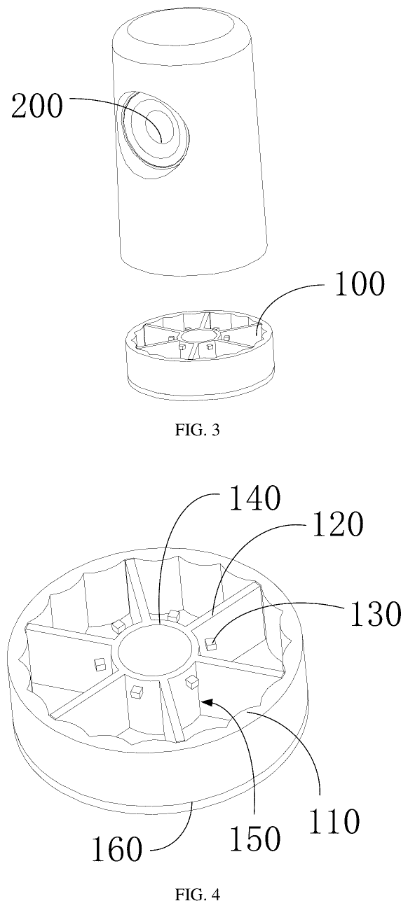

The above-mentioned loudspeaker box includes a loudspeaker box body, a sound effect system 200, and the above-mentioned light-emitting device 100. The sound effect system 200 includes a loudspeaker 210 and a main circuit board 220 connected to each other. The main circuit board 220 is configured to control the variation of the light sources of the light-emitting device 100 according to an audio signal. The light-emitting device 100 is arranged at a bottom of the loudspeaker box body. As shown in FIG. 1 to FIG. 4, during use, the light source of the light-emitting device 100 may change synchronously with the music rhythm and project dynamic strip light beams into the external space. With strong interactivity, it enhances the atmosphere, artistic appeal, and expressiveness of the music, enriches the user's audio-visual experience, and improves the value dimension of the loudspeaker box product.

The main circuit board 220 controls the light sources in the chambers 150 of the light-emitting device 100 to be lit sequentially in a clockwise or counterclockwise direction, thereby realizing a dynamic effect of the light beams rotating clockwise or counterclockwise. By controlling a switching frequency of each light source, a rotation speed of the light beams is adjusted to realize synchronous variation with the music rhythm. In addition, the main circuit board 220 controls the current intensity of each light source to change the length and brightness of the light beams, thereby achieving a scaling effect of the light beams in a length direction.

In some embodiments, the loudspeaker box further includes a housing. The sound effect system 200 is arranged in the housing. The light-emitting device 100 is connected to a bottom of the housing.

In some embodiments, the housing may be in any structural form as long as it can be connected to the light-emitting device 100 and seal the chambers 150 from the external environment. In some embodiments, the housing is a cylindrical structure or a structure close to a cylindrical shape with a cavity inside. The housing is connected to sides of the condensing lenses 110 away from the base plate 160. The housing is connected to the sides of the condensing lenses 110 away from the base plate 160 by bonding or clamping.

The technical features of the above embodiments may be arbitrarily combined. To make the description concise, not all possible combinations of the technical features in the above embodiments are described. However, as long as there is no contradiction in the combination of these technical features, they should be considered to be within the scope of this specification.

The above embodiments only express several implementations of the present disclosure, and the descriptions thereof are relatively specific and detailed, but they cannot be understood as limiting the scope of the present disclosure. It should be pointed out that, for those of ordinary skill in the art, several variations and improvements may be made without departing from the concept of the present disclosure, and these all belong to the protection scope of the present disclosure. Therefore, the protection scope of the present disclosure shall be subject to the attached claims.

1. A light-emitting device, comprising:
at least two condensing lenses, connected in sequence, wherein at least one of the condensing lenses forms a group, a partition plate is arranged between two adjacent groups of the at least one of the condensing lenses, and each group of the at least one of the condensing lenses and two partition plates adjacent to the group of the at least one of the condensing lenses form a chamber; and
at least two light sources, wherein at least one of the light sources is arranged in each chamber, and a light beam emitted by the at least one of the light sources is projected towards a corresponding group of the at least one of the condensing lenses and passes through to the outside of a corresponding chamber.

2. The light-emitting device according to claim 1, wherein the condensing lenses are connected one-by-one to form a ring structure, and the ring structure is configured to receive the light beam along an entire circumference of the ring structure and to project the light beam to the outside of the chamber.

3. The light-emitting device according to claim 1, wherein each of the light sources comprises a lamp bead, each of the condensing lenses is a convex lens, and an incident surface of each convex lens is perpendicular or approximately perpendicular to a light ray of a corresponding lamp bead.

4. The light-emitting device according to claim 1, wherein the light-emitting device further comprises a base plate, the condensing lenses, the partition plates, and the light sources are all arranged on the base plate, and the base plate is configured to be connected to a loudspeaker box.

5. The light-emitting device according to claim 1, wherein the light-emitting device further comprises a connecting structure, and a side of each partition plate away from the condensing lenses is connected to the connecting structure.

6. The light-emitting device according to claim 5, wherein the light-emitting device further comprises a first lamp board, the first lamp board is covered on the connecting structure, the light sources are connected to the first lamp board, and each of the light sources corresponds to a position of the corresponding chamber; wherein the connecting structure comprises a reflecting surface for reflecting light rays of the light sources into incident surfaces of the condensing lenses.

7. The light-emitting device according to claim 6, wherein the number of the at least one of the light sources in each chamber is two, both two light sources are arranged on the first lamp board, and in a case where the two light sources in the chamber are lit respectively, light beams are able to be emitted from the at least one of the condensing lenses of the chamber to different positions in an external space.

8. The light-emitting device according to claim 7, wherein the two light sources comprise a first lamp bead and a second lamp bead, each chamber is arranged with the first lamp bead and the second lamp bead, and the first lamp bead and the second lamp bead are both connected to the first lamp board; wherein in a case where the first lamp bead is lit, a first light beam is able to be emitted to the external space, in a case where the second lamp bead is lit, a second light beam is able to be emitted to the external space, and positions of the first light beam and the second light beam projected in the external space are different.

9. The light-emitting device according to claim 5, wherein the light-emitting device further comprises a second lamp board, the second lamp board is arranged in the chamber, and the at least one of the light sources is connected to the second lamp board.

10. The light-emitting device according to claim 1, wherein each group of the at least one of the condensing lenses forms an arc-shaped structure, sides of each two adjacent partition plates away from the condensing lenses are connected to each other, and each arc-shaped structure and two partition plates adjacent to the arc-shaped structure form a fan-shaped chamber.

11. The light-emitting device according to claim 1, wherein the condensing lenses are connected in sequence and arranged side by side, the light-emitting device further comprises a side plate, a side of each partition plate away from the condensing lenses is connected to the side plate, and each group of the at least one of the condensing lenses, two partition plates adjacent to the group of the at least one of the condensing lenses, and the side plate form a columnar chamber.

12. The light-emitting device according to claim 1, wherein in each group of the at least one of the condensing lenses, the number of the at least one of the condensing lenses is set to two or more than two.

13. The light-emitting device according to claim 12, wherein in each group of the at least one of the condensing lenses, an incident surface and an exit surface of each of the condensing lenses are curved surfaces with different radians.

14. The light-emitting device according to claim 1, wherein the condensing lenses form six groups, the six groups of condensing lenses form six chambers respectively, with each of the six chambers being defined by two partition plates adjacent to a corresponding group of condensing lenses, and the light sources in the six chambers are respectively set to emit light of a first color, a second color, a third color, a fourth color, a fifth color, and a sixth color.

15. A loudspeaker box, comprising:
a loudspeaker box body;
a light-emitting device, wherein the light-emitting device is arranged at a bottom of the loudspeaker box body; and
a sound effect system, comprising a loudspeaker and a main circuit board connected to each other, wherein the main circuit board is configured to control a variation of the light sources according to an audio signal;
wherein the light-emitting device comprises:
at least two condensing lenses, connected in sequence, wherein at least one of the condensing lenses forms a group, a partition plate is arranged between two adjacent groups of the at least one of the condensing lenses, and each group of the at least one of the condensing lenses and two partition plates adjacent to the group of the at least one of the condensing lenses form a chamber; and
at least two light sources, wherein at least one of the light sources is arranged in each chamber, and a light beam emitted by the at least one of the light sources is projected towards a corresponding group of the at least one of the condensing lenses and passes through to the outside of a corresponding chamber.

16. The loudspeaker box according to claim 15, wherein the condensing lenses are connected one-by-one to form a ring structure, and the ring structure is configured to receive the light beam along an entire circumference of the ring structure and to project the light beam to the outside of the chamber.

17. The loudspeaker box according to claim 15, wherein each of the light sources comprises a lamp bead, each of the condensing lenses is a convex lens, and an incident surface of each convex lens is perpendicular or approximately perpendicular to a light ray of a corresponding lamp bead.

18. The loudspeaker box according to claim 15, wherein each group of the at least one of the condensing lenses forms an arc-shaped structure, sides of each two adjacent partition plates away from the condensing lenses are connected to each other, and each arc-shaped structure and two partition plates adjacent to the arc-shaped structure form a fan-shaped chamber.

19. The loudspeaker box according to claim 15, wherein the condensing lenses are connected in sequence and arranged side by side, the light-emitting device further comprises a side plate, a side of each partition plate away from the condensing lenses is connected to the side plate, and each group of the at least one of the condensing lenses, two partition plates adjacent to the group of the at least one of the condensing lenses, and the side plate form a columnar chamber.

20. The loudspeaker box according to claim 15, wherein in each group of the at least one of the condensing lenses, the number of the at least one of the condensing lenses is set to two or more than two.
